(19) United States
(12) Patent Application Publication
(10) Pub. No.: US 2026/0178853 A1
(43) Pub. Date: Jun. 25, 2026

(54) LANGUAGE CONSTRUCTS FOR MULTI-PLATFORM CONNECTIVITY

(71) Applicant: Salesforce, Inc., San Francisco, CA (US)

(72) Inventors: Pablo Gerardo Kraan BRUN, Buenos Aires (AR); Mariano Jose De ACHAVAL, Buenos Aires (AR); Guillermo Sebastian FERNANDES, Buenos Aires (AR); Nicolas ZDANOVICZ, Buenos Aires (AR)

(73) Assignee: Salesforce, Inc., San Francisco, CA (US)

(21) Appl. No.: 18/991,079

(22) Filed: Dec. 20, 2024

(51) Int. Cl. G06F 40/58; G06F 9/54

(52) U.S. Cl. CPC G06F 40/58; G06F 9/541

(57) ABSTRACT

Disclosed herein are system, method, and computer program product aspects for generating a connector using a connectivity language, which would generate a basic connectivity model from an artifact and allow for customization by developers, enabling reusability and support for new artifacts across different platforms. The methods include generating connectors for an external platform using the connectivity language and translating artifacts from the external platform using said connectors. The translated artifacts are used to connect an integration platform with an external platform.

### BACKGROUND

Integration platforms allow organizations to design, implement, and deploy software tools that integrate and harness heterogeneous resources (e.g., applications, services, and data sources) from across the organization's technical landscape. An integration platform may build integration applications, retrieve and transform data, interact with various application programming interfaces (APIs), deploy integration applications to users, and otherwise maintain integration applications. In some cases, connectors may be used in the integration platform to connect applications to external APIs, including transmitting and receiving messages over a protocol to and from an API, and processing these messages. Connectors provide methods to abstract connections and execution against an external system. These connectors provide a common abstraction and a better user experience than connecting using HTTP or other low-level protocols.

Each integration platform defines its concept of a connector, in particular, how to model a connection, how to consume the connected API, which language and API must be used to define a connector, how to package the connector, and other functionalities. Because of this, providing connectivity to a given application or service requires building a dedicated connector per platform.

With the increasing number of APIs being available and the increasing number of integration platforms, creating dedicated connectors per platform does not scale cost-effectively.

### BRIEF DESCRIPTION OF THE DRAWINGS

The accompanying drawings are incorporated herein and form a part of the specification.

FIG. 1 illustrates a block diagram of an exemplary integration environment, according to aspects of the present disclosure.

FIG. 2 illustrates a block diagram of an exemplary sequence of events for generating a connector in an integration environment, according to aspects of the present disclosure.

FIG. 3 illustrates a flowchart diagram of an exemplary method for connector generation, according to aspects of the disclosure.

FIG. 4 illustrates a block diagram of an exemplary computer system according to aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for generating connectors using a connectivity language.

An organization's enterprise landscape may incorporate a wide-array of applications, services, data sources, servers, and other resources. Applications in the landscape may be varied and numerous and include: custom-built applications, legacy applications, database applications, cloud-based applications, and enterprise-resource-planning applications, just to name a few examples. These applications and their associated data may reside on different servers in different locations or data centers and/or be accessed via the cloud.

An integration platform may allow users to create useful business processes, applications, and other software tools that will be referred to herein as integration applications, integration scenarios, and/or integration flows. Integration flows may leverage data from the organization's disparate systems and applications. An integration platform may bridge divides between technical resources by centralizing communications. The integration platform may include message buses/protocols to facilitate communication between applications, data flow coordinators, connectors, security and data protection, dashboards and analysis tools, APIs, and other suitable tools.

Users may employ connectors to build integrations providing connection between integration flows in the integration platform and external services. In some cases, there may be a growing number of specialized APIs, and the number of existing connectors available in the integration platform for connecting to each API may be limited. Thus, users (e.g., developers) may currently need to customize existing connectors or build their own connectors by writing code for various use case scenarios in the integration platform. In some cases, each connector may incorporate a large number of fields, and it may be difficult and time-consuming for users to manually code connector modules as needed.

Thus, in order to minimize the need for users coding their own connectors and simplify connector creation, disclosed herein are system, apparatus, device, method and/or computer program product embodiments for a connectivity language that generates a basic connectivity model from an API specification (spec) and allows for customization by developers, enabling reusability and support for configuring external resources, such as databases, APIs for software as a service (SaaS) applications, or the like across different platforms.

It is to be noted that while API specs are used to describe the exemplary methods herein, any artifact type (e.g., data models, prototypes, workflow diagrams, documents, scripts, code, and the like) may be used in the following system, apparatus, device, method and/or computer program product aspects, and/or combinations and sub-combinations thereof.

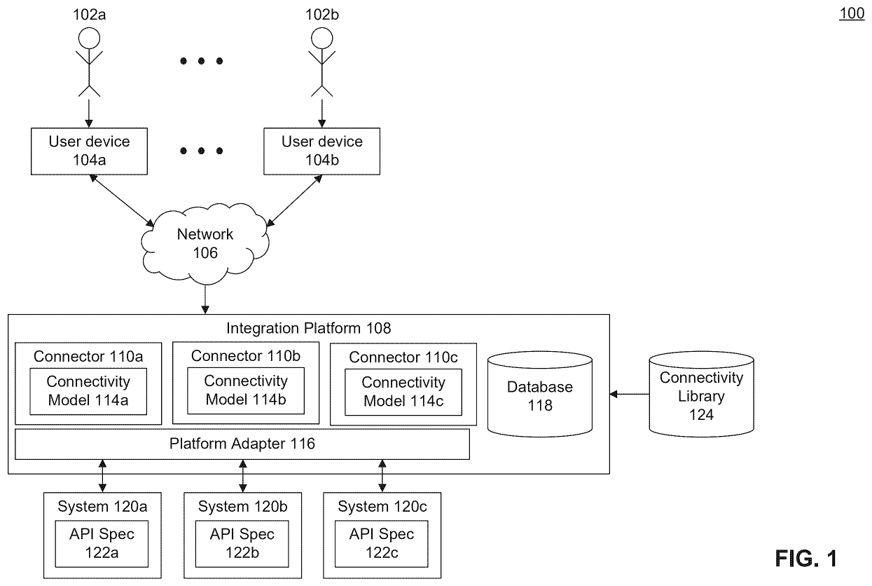

FIG. 1 is a block diagram of environment 100 of an integration platform, according to some embodiments. Any operation herein may be performed by any type of structure in the diagram, such as a module or dedicated device, in hardware, software, or any combination thereof. Any block in the block diagram of FIG. 1 may be regarded as a module, apparatus, dedicated device, general-purpose processor, engine, state machine, application, functional element, or related technology capable of and configured to perform its corresponding operation(s) described herein. Environment 100 may include users 102(a)-102(b), devices 104(a)-104(b), network 106, integration platform 108, and systems 120.

Users 102(a)-102(b) may represent a plurality of developers or other individuals designing, developing, and deploying integration flows using an integration platform 108. In some embodiments, users 102(a)-102(b) may be referred to herein as users 102. One or more users 102 may be members of a business, organization, and/or other suitable group. One or more users 102 may be human beings, but one or more users 102 may also be artificial intelligence constructs.

Devices 104(a)-104(b) may be associated with users 102(a)-102(b), in which each device 104 may correspond to and be operated by a user 102. In some embodiments, devices 104(a)-104(b) may be referred to herein as devices 104. Each device 104 may be a personal digital assistant, desktop workstation, laptop or notebook computer, netbook, tablet, smart phone, mobile phone, smart watch or other wearable, appliance, augmented reality (AR) device, virtual reality (VR) device, part of the Internet-of-Things, and/or embedded system, to name a few non-limiting examples, or any combination thereof. In some embodiments, each device 104 may include one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by integration platform 108. For example, the user interface device can be used to build integrations using integration platform 108, access data and applications hosted by systems 120, perform searches on stored data, and otherwise allow one or more of users 102 to interact with various GUI pages that may be presented to the one or more of users 102.

Devices 104 might communicate with integration platform 108 and/or systems 120 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more devices 104 might include an HTTP client, commonly referred to as a “browser,” for sending and receiving HTTP messages to and from server(s) of integration platform 108 and/or systems 120, thus allowing users 102 of the devices 104 to access, process and view information, pages and applications available to it from integration platform 108 and/or systems 120 over a network 105.

Users 102 may employ devices 104 to connect to network 106. Network 106 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between integration platform 108, systems 120, and/or devices 104.

Integration platform 108 may allow users 102 to build integrations and/or APIs, and design integration applications that access, manipulate, and otherwise use disparate technical resources. In some embodiments, integration platform 108 may allow users 102 to build integrations providing connections to third-party systems and data, and provide additional functionalities to further integrate data from a wide-array of organizational and on-the-cloud data sources. Integration platform 108 may include one or more user interface components to render a user interface for users 102 via devices 104. In some embodiments, integration platform 108 may provide a user interface that allows users 102 to select and design various connectors 110 and/or other components, such as APIs, templates, examples, and other components stored within database 118 in integration platform 108.

In some embodiments, integration platform 108 may include a JavaScript user interface library to control dynamic interactions between users 102 and integration platform 108 and/or a development toolkit facilitating the building of HTML5 or mobile applications. In some embodiments, integration platform 108 may allow a business or organization to upgrade components used by integration platform 108 in order to change the experience for users 102 over time.

Integration platform 108 may also include runtime components to build, assemble, compile, or otherwise create executable object code for specific integration scenarios to allow an integration application to function at runtime. In some embodiments, runtime components may create interpreted code to be parsed and applied upon execution. In some embodiments, runtime components may include a variety of intermediary hardware and/or software that runs and processes the output of integration flows. In some embodiments, integration platform 108 may connect to ancillary systems to retrieve, store, and manipulate data using an appropriate API or other method.

Integration platform 108 includes connectors 110a-c, connectivity models 114a-c, and platform adapter 116. In some aspects, integration platform 108 may further include an API loader (not shown). Connectors 110 may represent a plurality of connectors comprising preconfigured functions that users 102 may leverage to connect to particular data sources or for using particular data protocols. In some embodiments, users 102 might not find a specific connector 110 in integration platform 108 for a specific application in which they are interested. Thus, users 102 may configure connectors 110 to access specific applications and/or build specific integration flows using a connectivity language comprising preconfigured functions stored in connectivity library 124.

Connectivity library 124 provides preconfigured functions that define connectivity in an interpreted connectivity language that models connectivity concepts in a way that is agnostic of the integration platform. This connectivity language is a functional programming language based on function composition and immutable data. The connectivity language provides basic connectivity functions that represent concepts for providing connectivity to external services. Because the connectivity language is interpreted and agnostic from integration platforms, it enables users 102 to share and reuse connectivity functions across different integration platforms. Additionally, the connectivity language provides mechanisms to modularize and extend required connectivity functions so that integration platforms can define additional connectivity functions that can be modeled using the connectivity language. Because the connectivity language is modular and extensible, it may be used across a plurality of integration platforms to create connectivity for a plurality of external services.

In some embodiments, connectivity library 124 includes a plurality of preconfigured functions. For example, the plurality of preconfigured functions may include, but is not limited to, type, connection, operation, connection tests, triggers, value provider, dynamic metadata provider, pagination, sample data provider, and query building. Each preconfigured function is described below.

A type models the format of different elements of an API spec (e.g., input parameters, endpoint responses, etc.). Types may include simple types (e.g., number, string, Boolean, etc.), arrays, objects, and other complex types. In some embodiments, the type construct may include, but is not limited to, metadata related to connectivity, labels, descriptions, and enrichers to retrieve values.

A connection type models how the integration platform is to connect to an external service. In some embodiments, it may also model different authentication methods that are available in order to connect. The connection type defines the connection information needed to build the connection. In some embodiments, the preconfigured functions may further comprise transport-specific connection models that simplify a connection's definition.

An operation function provides the execution of an endpoint on the external service. In some embodiments, the operation describes an action with its contract, input, context (i.e., connection), and result in success or failure. In some embodiments, the operation function may provide execution of multiple endpoints or have conditional logic in order to select between multiple endpoints based on pre-defined logic.

A connection test type includes methods to test that a configured connection is valid by testing the consumption of a given operation and asserting on the response.

A trigger function provides models to read data from an external service and track the progress of the data processing (e.g., watermarking) to avoid processing the same record twice.

A value provider function provides a model to retrieve values from the external service and map them to a user-friendly label such that users are exposed to the user friendly label when configuring connectivity. For example, the value may be account IDs implemented using a UUID and the value provider function may map the account ID to an account name for a user-friendly label.

A dynamic metadata provider provides a model to dynamically change and describe the input and/or output types of a connectivity function (e.g., trigger or operation) based on the value of other values configured in the same function.

A pagination function provides a model for easing the consumption of paginated endpoints that can be invoked to retrieve pages and/or sets of data. In some embodiments, the connectivity language represents the result of the split as a Page that defines the value associated with the current page result and a nextPage object that makes the next call to retrieve the next page and so on. The model must build and set the next call to the object that retrieves the next page. The integration platform holds the state of the current Page and makes the call to move to the next page. The final page in the pagination would not have a nextPage value.

A sample data provider function provides a model to retrieve values from the external service using a configured connector and displays examples of the data that the integration platform will retrieve.

A query builder function provides a model that defines components to build queries that retrieve data from the external service using an SQL-like model.

Using the connectivity library 124, a connectivity model 114 is generated for each system 120 in the integration platform 108. Connectivity model 114 defines which connectivity functions and capabilities will be required in connector 110 to create integration based on the requirements of integration platform 108. In some embodiments, integration platform 108 requires connectivity model 114 to include the type, connection, and operations functions, which provide basic connectivity. In some embodiments, the basic connectivity model 114 may be automatically generated by integration platform 108.

Users 102 may further customize connectivity model 114 by customizing or adding additional functions to connectivity model 114 based on the API specs 122 of external services (i.e., systems 120) using the connectivity language. In some embodiments, integration platform 108 may add additional functions to connectivity model 114 including, but not limited to, connection tests, triggers, value provider, dynamic metadata provider, pagination, sample data provider, and query building, based on API spec 122. In some aspects, the additional functions may be preconfigured functions stored in connectivity library 124.

In some embodiments, users 102 may select and customize the preconfigured functions based on the requirements of API specs 122. In some embodiments, users 102 may select and customize preconfigured functions that are not described by API specs 122. In some embodiments, users 102 may code functions within connectivity model 114 from scratch in the connectivity language.

In some embodiments, the API specs 122 may be retrieved by an API loader to generate connector 110. The API loader provides an extensible architecture that enables the support of a plurality of API spec formats. In some embodiments, connector 110 may be automatically generated when an API spec is retrieved or received by the API loader. In some embodiments, connector 110 may be updated when an updated API spec 122 is retrieved by the API loader for a system 120.

Using connector 110, platform adapter 116 may connect systems 120a-c by deploying connectors 110a-c, respectively. For example, platform adapter 116 may adapt connectors 110a and 110b and execute interactions between systems 120a and 120b..

An example of an integration is provided below. This integration is merely exemplary, however, and one skilled in the relevant arts will appreciate that integrations may perform a vast and expansive array of functions that may differ between individuals and among organizations. Some integrations may incorporate dozens or even hundreds of assets into the integration scenario.
In one example of an integration, a user 102 may want to connect to a communication platform system through the integration platform 108. However, a connector 110 might not be available in the integration platform 108. Thus, the user 102 may configure a new connector 110 (e.g., an HTTP connector) to directly call an API corresponding to the communication platform system through the integration platform 108. The API loader 112 may load and translate an API spec of the API using platform adapter 116 for the communication platform system to provide configuration information. The user 102 may then test the connection and deploy the application to the integration platform 108.
In other use-case examples of integrations in the integration platform 108, other users 102 may call new APIs, add triggers to existing connectors 110, further customize existing connectors 110, and the like. In order to build each of the different integrations, each preconfigured function in the connectivity language may configure a large number of fields and/or customize properties using the connectivity model 114. Accordingly, in order to capture the various needs and customizations of different external services, the connectivity language may allow users 102 to further customize a connector by customizing the connectivity model 114 using an API spec.

Database 118 may be any of a collection of data storage systems housing information relevant to, used in, and stored by integration platform 108 including information integration flows, connectors 110, and the like. For instance, database 118 may be a database management system or relational database tool. Database 118 may further be a message queue or stream processing platform such as Apache Kafka or Apache Spark or other data storage systems like Apache Hadoop, HDFS, or Amazon S3, to name just some examples. Database 118 may be a data lake, data silo, semi-structured data system (CSV, logs, xml, etc.), unstructured data system, binary data repository, or other suitable repository. Database 118 may store thousands, millions, billions, or trillions (or more) of objects, rows, transactions, records, files, logs, etc. while allowing for the creation, modification, retrieval, archival, and management of this data. In an embodiment, database 118 uses scalable, distributed computing to efficiently catalog, sort, manipulate, and access stored data.

Systems 120, such as system 120A, system 120B, and system 120C, may be an API, data source or other technical resource or system to be included in an integration flow. While three systems 120 are illustrated in FIG. 1 for reference, there may be any number of systems 120 in the environment 100. In some embodiments, systems 120 may represent a plurality of applications or other platforms with which users 102 may want build integrations using integration platform 108. In some embodiments, systems 120 include API specs 122 that details the functional and expected behavior of the plurality of applications or other platforms. Systems 120 may house data in a number of fashions, such as in a suitable data repository, either in a raw form or following (or at an intermediate step within) the application of a transformational capability. Systems 120 may include data lakes, data silos, message streams, relational databases, semi-structured data (CSV, logs, xml, etc.), unstructured data, binary data (images, audio, video, etc.), or other suitable data types in appropriate repositories, both on-premises and on the cloud. Just for example, systems 120 may provide data or functionalities by connecting to a CRM system, an ERP system, a database, an internet-Of-Things device, a mobile phone, a watch, a JIRA tasklist, a revision control system or other code management tool, and/or a multitude of other sources.

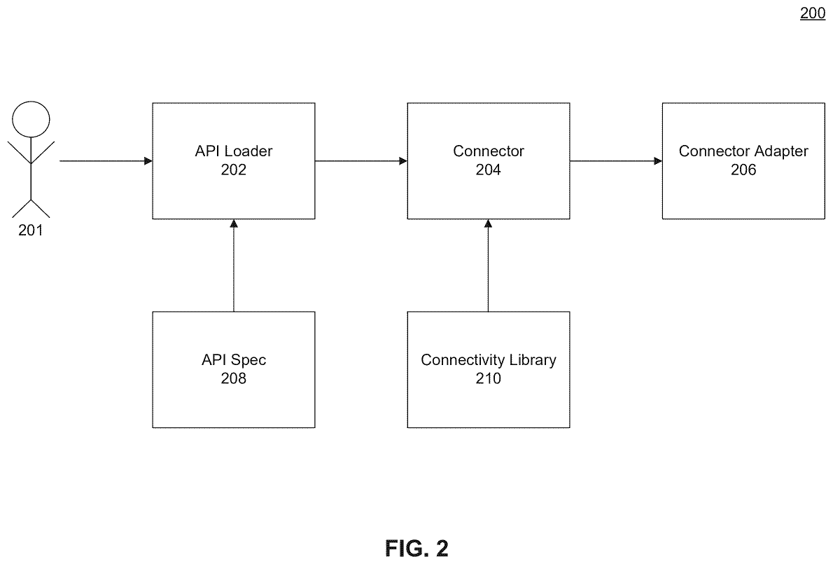

FIG. 2 is a block diagram illustrating a sequence of events for dynamically generating a connector in an integration platform, according to some embodiments. In particular, FIG. 2 shows a sequence of events or interactions between a connector developer 201, API loader 202, connector 204, connector adapter 206, API spec 208, and connectivity library 210 in an integration platform. In some embodiments, connector developer 201, connector 204, connector adapter 206, API spec 208, and connectivity library 210 may represent exemplary embodiments of user 102, platform adapter 116, connectors 110, API spec 122, and connectivity library 124, respectively, shown in FIG. 1.

In a first event, connector developer 201 may engage with API loader 202 through a user interface shown on a device (e.g., device 104) of the connector developer 201. In some embodiments, connector developer 201 may engage with API loader 202 by configuring API loader 202 to call a new API, including providing configuration information, specifically API spec 208.

In a second event, data from API loader 202 may be converted into connector 204 for a particular integration platform using the preconfigured functions from connectivity library 210. In some embodiments, the data from API loader 202 may be used to update an existing connector 204. In some embodiments, the connector 204 may be made available for connector developers to access via the integration platform user interface.

In a third event, the connector 204 is used on the particular integration platform through connector adapter 206.

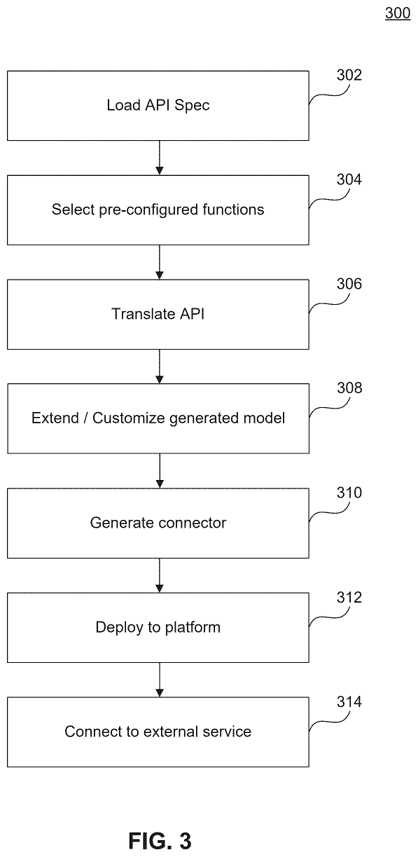

FIG. 3 illustrates a method 300 for generating connectors using a connectivity language, according to some embodiments. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, the integration platform 108 may collect API specs of external services to build integrations in the integration platform 108, as described above with reference to FIGS. 1 and 2. In some embodiments, the API loader in integration platform 108 may be used to collect the API specs of external services. In some embodiments, the integrations may be between at least one external resource, one or more applications, or one or more application programming interfaces (APIs).

In 304, the integration platform 108 may select preconfigured functions defining the connectivity language based on the API spec. In some embodiments, the preconfigured functions are selected automatically based on the requirements of integration platform 108. In some embodiments, the preconfigured functions are selected by users 102 based on the requirements of the external service or the API spec. The preconfigured functions are based on connectivity parameters for creating connectivity including, but not limited to, type, connection, operation, connection tests, triggers, value provider, dynamic metadata provider, pagination, sample data provider, and query building. In some embodiments, the preconfigured functions may be customized by users 102 or automatically based on the API spec.

In 306, the API spec is translated into the connectivity language to generate a connectivity model for the external service.

In 308, the connectivity model may be extended or customized using the connectivity language. In some embodiments, the extending and customizing may include developing composed operations that execute against multiple endpoints or have conditional logic to choose between multiple endpoints based on some logic. In some embodiments, the composed operations may be connection tests, triggers, value provider, dynamic metadata provider, pagination, sample data provider, and query building.

In 310, integration platform 108 generates a connector using the connectivity model. The connector may be stored in database 118 and accessible to users 102 through a user interface provided by integration platform 108.

In 312, integration platform 108 deploys the connector using platform adapter 116. In some embodiments, the external service may define how the connector is deployed and used in the context of integration. For example, the external service may define constraint in terms of class loading isolation or based on limits of resources within the system (e.g., memory, CPU, file systems, etc.). In some embodiments, the connector may be packaged inside an application and deployed inside a runtime for the application. In other embodiments, the connector may be deployed on a cloud service as a SaaS that executes data extraction. In some embodiments, the connector may be deployed as an invocable action.

In 314, integration platform 108 is connected to the external service using the generated connector.

It will be understood that the order of the above process steps are merely exemplary, and the steps can be rearranged in any appropriate manner, and that the process can be modified consistent with the present disclosure. Additionally, more or fewer steps may be included in the exemplary method consistent with the disclosure.

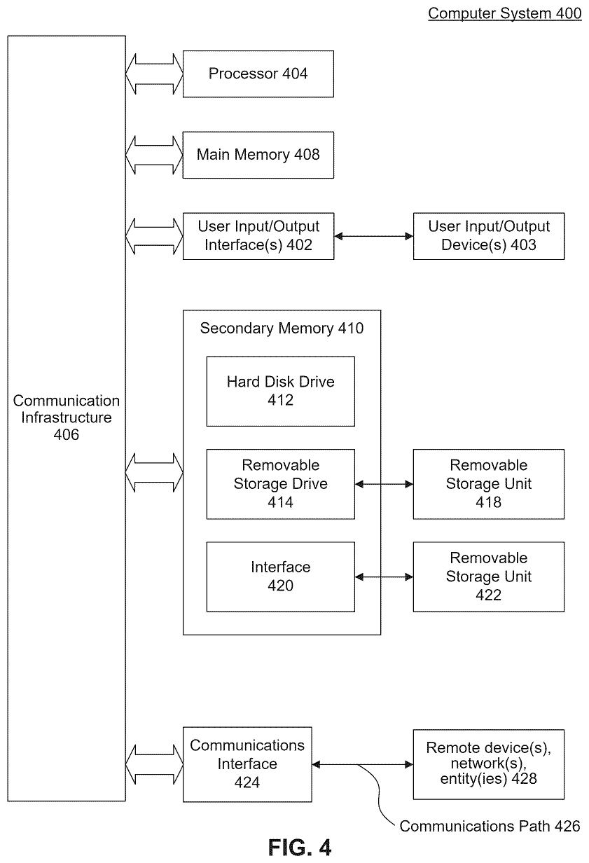

Various aspects may be implemented, for example, using one or more well-known computer systems, such as computer system 400 shown in FIG. 4. One or more computer systems 400 may be used, for example, to implement any of the aspects discussed herein, as well as combinations and sub-combinations thereof, including but not limited to the integration platform 108, devices 104, and systems 120.

Computer system 400 may include one or more processors (also called central processing units, or CPUs), such as a processor 404. Processor 404 may be connected to a communication infrastructure or bus 406.

Computer system 400 may also include customer input/output device(s) 403, such as monitors, keyboards, pointing devices, etc., which may communicate with communication infrastructure 406 through customer input/output interface(s) 402.

One or more of processors 404 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random-access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings included in this disclosure, it will be apparent to persons skilled in the relevant art(s) how to make and use aspects of this disclosure using data processing devices, computer systems and/or computer architectures other than that shown in FIG. 4. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method, comprising:
generating, by the one or more computing devices, a connectivity model comprising a set of pre-configured functions defining a connectivity language;
translating, by the one or more computing devices, an artifact for an external platform into the connectivity language using the connectivity model;
generating, by the one or more computing devices, a connector based on the translated artifact; and
connecting, by the one or more computing devices, to the external platform via the connector adapted by a platform adapter.

2. The method of claim 1, wherein the translating comprises translating connectivity parameters defined by the artifact for connecting to the external platform, the artifact being an API specification, wherein the connecting to the external platform is based on the connectivity parameters.

3. The method of claim 2, wherein the connectivity parameters comprise a type, a connection, and operations for connecting to the external platform.

4. The method of claim 2, wherein the connectivity parameters comprise at least one of connection testing, triggers, value providers, dynamic metadata providers, paginated operations, sample data providers, or a query builder for connecting to the external platform.

5. The method of claim 1, wherein the connectivity language is agnostic from a language used by the external platform.

6. The method of claim 1, further comprising:
translating, by the one or more computing devices, an updated artifact from the external platform into the connectivity language; and
connecting, by the one or more computing devices, to the external platform via an updated connector for the updated translated artifact using the platform adapter.

7. The method of claim 1, further comprising:
updating, by the one or more computing devices, the set of pre-configured functions with customized functions.

8. A system, comprising:
a memory configured to store operations; and
one or processors configured to perform the operations, the operations comprising:
generating a connectivity model comprising a set of pre-configured functions defining a connectivity language;
translating an artifact for an external platform into the connectivity language using the connectivity model;
generating a connector based on the translated artifact; and
connecting to the external platform via the connector adapted by a platform adapter.

9. The system of claim 8, wherein the translating comprises translating connectivity parameters defined by the artifact for connecting to the external platform, the artifact being an API specification, wherein the connecting to the external platform is based on the connectivity parameters.

10. The system of claim 9, wherein the connectivity parameters comprise a type, a connection, and operations for connecting to the external platform.

11. The system of claim 9, wherein the connectivity parameters comprise at least one of connection testing, triggers, value providers, dynamic metadata providers, paginated operations, sample data providers, or a query builder for connecting to the external platform.

12. The system of claim 8, wherein the connectivity language is agnostic from a language used by the external platform.

13. The system of claim 8, further comprising:
translating an updated artifact from the external platform into the connectivity language; and
connecting to the external platform via an updated connector for the updated translated artifact using the platform adapter.

14. The system of claim 8, wherein the generating further comprises:
updating the set of pre-configured functions with customized functions.

15. A non-transitory computer-readable storage device having instructions stored thereon, execution of which, by one or more processing devices, causes one or more processors to perform operations comprising:
generating a connectivity model comprising a set of pre-configured functions defining a connectivity language;
translating an artifact for an external platform into the connectivity language using the connectivity model;
generating a connector based on the translated artifact;
connecting to the external platform via the connector adapted by a platform adapter.

16. The non-transitory computer-readable storage device of claim 15, wherein the translating comprises translating connectivity parameters defined by the artifact for connecting to the external platform, the artifact being an API specification, wherein the connecting to the external platform is based on the connectivity parameters.

17. The non-transitory computer-readable storage device of claim 16, wherein the connectivity parameters comprise a type, a connection, and operations for connecting to the external platform.

18. The non-transitory computer-readable storage device of claim 16, wherein the connectivity parameters comprise at least one of connection testing, triggers, value providers, dynamic metadata providers, paginated operations, sample data providers, or a query builder for connecting to the external platform.

19. The non-transitory computer-readable storage device of claim 15, further comprising:
translating an updated artifact from the external platform into the connectivity language; and
connecting to the external platform via an updated connector for the updated translated artifact using the platform adapter.

20. The non-transitory computer-readable storage device of claim 15, further comprising:
updating the set of pre-configured functions with customized functions.
